(19) United States
(12) Patent Application Publication
(10) Pub. No.: US 2012/0204209 A1
(43) Pub. Date: Aug. 9, 2012

(54) CONTENT PROCESSING DEVICE, TELEVISION RECEIVER, AND CONTENT PROCESSING METHOD

(76) Inventor: Seiji Kubo, Osaka (JP)

(21) Appl. No.: 13/322,274

(22) PCT Filed: May 27, 2011
(86) PCT No.: PCT/JP2011/002989

§ 371 Date: Nov. 23, 2011

(30) Foreign Application Priority Data
Jun. 1, 2010 (JP) 2010-125885

(51) Int. Cl. H04N 21/431

(52) U.S. Cl. 725/34

(57) ABSTRACT

A content processing device (10) includes the following units. A content obtainment unit (13) obtains a current viewing content from a first source selected by a user, and obtains a candidate viewing content from a second source different from the first source. A content output unit (15) outputs at least the current viewing content. A detection unit (11) detects a user who is estimated as being interested in the current viewing content. A control unit (12) increases an amount of information of the candidate viewing content outputted from the content output unit (15), as a time period during which the detection unit (11) has not detected, the user estimated as being interested in the current viewing content becomes longer.

### TECHNICAL FIELD

The present invention relates to output control methods for controlling an output of a content processing device capable of receiving plurality of contents.

1. Background Art

Recently, with the advancement of communications networks, environments for viewing multimedia information including HDTV (High Definition TeleVision) and other images readily at home or the office via various distribution services have become widely available on the Internet. Internet-connectable TVs make it possible to obtain and enjoy viewing multimedia information such as described above. Furthermore, in addition to conventional practice whereby at the time of viewing, a user can view or record only programs determined by broadcasting stations in advance, video/audio services (program distribution services) have started in recent years which allow users to select desired programs at any desired time and view or record the programs via the Internet. Thus, a device which will allow users to easily view a content other than conventional TV broadcasting is expected to be developed.

2. Conventional Art(s)

### PATENT REFERENCE(S)

Patent Reference 1: Japanese Unexamined Patent Application Publication No. 2005-333524

### DISCLOSURE OF INVENTION

### Problems that Invention is to Solve

Patent Reference 1 discloses a program selection assistance device and program selection assistance program for a multiscreen display device which receives a plurality of programs using a plurality of tuners and displays the plurality of programs on a single screen, where the program selection assistance device and program selection assistance program are capable of changing display ratios among the programs displayed on the display according to viewing times of multiscreens.

However, this method is premised on multiscreen display and changes display regions of the multiscreens with the passage of time. Therefore, when a viewer wants to view a specific program, there is a problem in that sub-screens which are not viewed are always displayed on the screen although small, obstructing viewing.

In particular, the example described above does not give consideration to a method for offering both conventional TV broadcasting and another content than TV broadcasting to the user. For example, a method which always outputs a content other than TV broadcasting even if not selected by the user has the problem of reducing a viewing size of regular TV broadcasting, obstructing viewing.

The present invention has been made to solve the above problem, and it is an object of the present invention to provide a content processing device capable of outputting plurality of contents by automatically changing amounts of content information in such a way as to reduce obstruction to viewing by taking into consideration the interest level of the user in TV.

### Means to Solve the Problems

In accordance with an aspect of the present invention for achieving the object, there is provided a content processing device that outputs a content, the content processing device including: a content obtainment unit configured to obtain a current viewing content from a first source selected by a user, and obtain a candidate viewing content from a second source different from the first source; a content output unit configured to output at least the current viewing content; a detection unit configured to detect a user who is estimated as being interested in the current viewing content; and a control unit configured to increase an amount of information of the candidate viewing content outputted from the content output unit, as a time period during which the detection unit has not detected the user estimated as being interested in the current viewing content becomes longer.

With the above configuration, the interest level of the user in the current viewing content is estimated based on the time period during which the user is not detected. Specifically, the longer the time period during which the user is not detected, the lower the interest level is estimated to be, and the amount of information of a candidate viewing content different from the current viewing content is increased. This gives a cue for the user to view another content.

The detection unit may include an input operation detection unit configured to detect the user estimated as being interested in the current viewing content, by detecting input operation from the user, and the control unit is configured to increase the amount of the information of the candidate viewing content outputted from the content output unit, when the input operation detection unit has not detected the input operation from the user for a predetermined time period.

The detection unit may further include a content information detection unit configured to detect a time of ending the current viewing content, and the control unit is configured to increase, at the time of the ending detected by the content information detection unit, the amount of the information of the candidate viewing content outputted from the content output unit, when the input operation detection unit has not detected the input operation from the user for the predetermined time period. This prevents the screen or audio from being switched halfway through the current viewing content, and thus the user is not obstructed from viewing.

The detection unit may include a user detection unit configured to detect the user estimated as being interested in the current viewing content, by detecting the user around the content processing device, and the control unit is configured to increase the amount of the information of the candidate viewing content outputted from the content output unit, when the user detection unit has not detected the user around the content processing device for a predetermined time period.

The content obtainment unit is configured to obtain a plurality of candidate viewing contents including the candidate viewing content, and the control unit is configured to gradually increase the number of the candidate viewing contents outputted from the content output unit, as a time period during which the detection unit has not detected the user estimated as being interested in the current viewing content becomes longer. This makes it possible to provide a larger number of choices (candidate viewing contents) to the user with decreases in the interest level of the user.

The content output unit may include: a display unit configured to display video data included in the content; and an audio output unit configured to output audio data included in the content, and the control unit is configured to (a) control a display area on the display unit for displaying the video data included in the candidate viewing content, or (b) control the audio output unit whether or not to output the audio data included in the candidate viewing content.

The control unit may control the audio output unit to output audio data included in a content, the content including video data displayed on a largest display area on the display unit.

The content obtainment unit may select the candidate viewing content to be obtained, based on meta information included in the current viewing content. This makes it possible to obtain the candidate viewing content the user is likely to be interested in.

In accordance with another aspect of the present invention, there is provided a content processing device that outputs a content, the content processing device including: a content obtainment unit configured to obtain a current viewing content from a first source selected by a user, and obtain a candidate viewing content from a second source different from the first source; a content output unit configured to output at least the current viewing content; an input operation detection unit configured to detect input operation from the user; a control unit configured to increase an amount of information of the candidate viewing content outputted from the content output unit, when the input operation detection unit has not detected the input operation from the user for a predetermined time period.

In accordance with still another aspect of the present invention, there is provided a content processing device that outputs a content, the content processing device including: a content obtainment unit configured to obtain a current viewing content from a first source selected by a user, and obtain a candidate viewing content from a second source different from the first source; a content output unit configured to output at least the current viewing content; a user detection unit configured to detect the user around the content processing device; and a control unit configured to increase an amount of information of the candidate viewing content outputted from the content output unit, when the user detection unit has not detected the user around the content processing device for a predetermined time period.

The content obtainment unit may include: a broadcast receiving unit configured to receive the content via broadcast waves; and a network content receiving unit configured to obtain the content via a communication network.

In accordance with still another aspect of the present invention, there is provided a content processing method of outputting a content, the content processing method including: obtaining a current viewing content from a first source selected by a user, and a candidate viewing content from a second source different from the first source; outputting at least the current viewing content; detecting a user who is estimated as being interested in the current viewing content; and increasing an amount of information of the candidate viewing content outputted in the outputting, as a time period during which the user estimated as being interested in the current viewing content has not been detected in the detecting becomes longer.

### Effects of the Invention

The present invention makes it possible to provide plurality of contents by automatically switching among their output conditions after giving consideration to a viewing state of the user.

### BRIEF DESCRIPTION OF DRAWINGS

FIG. 1 is a block diagram for outlining a content processing device according to a first embodiment.

FIG. 2 is a flowchart showing how to perform state transitions of a screen on the content processing device according to the first embodiment.

FIG. 3 is a diagram showing an example of screens outputted by the content processing device according to the first embodiment based on state transitions.

FIG. 4 is a diagram showing an example of transitions of screens outputted by the content processing device according to the first embodiment based on state transitions.

FIG. 5 is a diagram showing an example of transitions of screens outputted by the content processing device according to the first embodiment based on state transitions.

FIG. 6 is a diagram showing an example of screens and audio outputted by the content processing device according to a variation of the first embodiment based on state transitions.

FIG. 7 is a diagram showing an example of transitions of screens and audio outputted by the content processing device according to the variation of the first embodiment based on state transitions.

FIG. 8 is a block diagram for outlining a content processing device according to a second embodiment.

FIG. 9 is a flowchart showing how to perform state transitions on the content processing device according to the second embodiment.

FIG. 10 is a block diagram for outlining a content processing device according to a third embodiment.

FIG. 11 is a diagram showing another example of screens outputted by the content processing device based on state transitions.

FIG. 12 is a diagram showing another example of screens outputted by the content processing device based on state transitions.

FIG. 13 is an overview diagram of a television receiver and BD recorder.

### BEST MODE FOR CARRYING OUT THE INVENTION

Concrete modes for carrying out the invention will be described below with reference to the drawings.

### First Embodiment

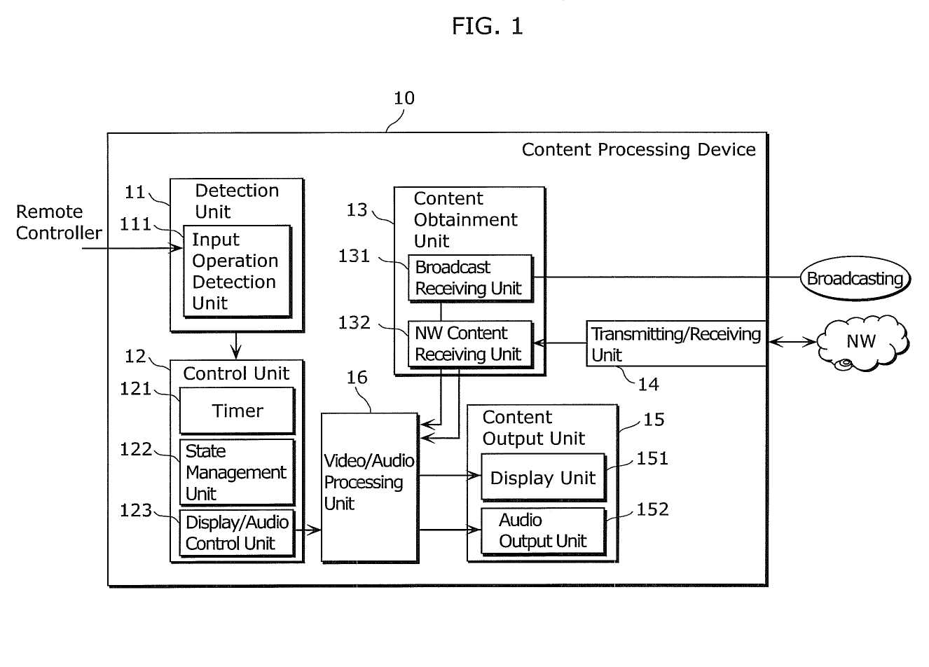

FIG. 1 is a block diagram for outlining a content processing device 10 according to a first embodiment. Referring to FIG. 1, the content processing device 10 includes a detection unit 11, a control unit 12, a content obtainment unit 13, a transmitting/receiving unit 14, a content output unit 15, and a video/audio processing unit 16.

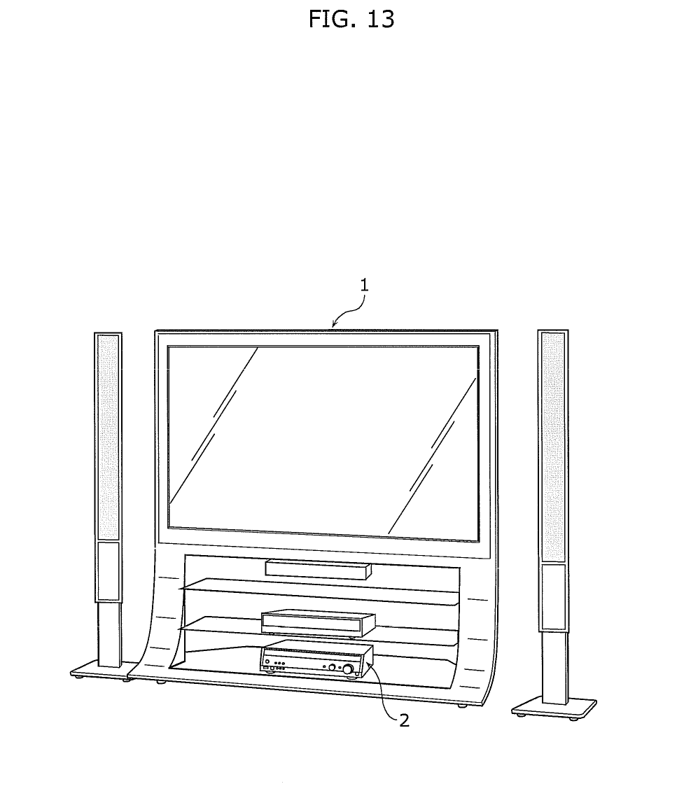

Concrete examples of the content processing device 10 include, but are not particularly limited to, a television receiver (hereinafter abbreviated to “TV”) 1 such as shown in FIG. 13 and a BD (Blu-ray Disc) recorder 2 (or DVD (Digital Versatile Disc) recorder) such as shown in FIG. 13.

The detection unit 11 detects various information. According to the first embodiment, the detection unit 11 includes an input operation detection unit 111 detects input operation of the user with respect to the content processing device 10 and thereby detect that the user is estimated as being interested in the current viewing content.

Typically the input operation detection unit 111 detects remote control operations performed by the user. That is, the input operation detection unit 111 receives a remote control operation signal from the remote controller, including specifics of the remote control operations performed by the user. The detection unit 11 sends the remote control operation signal detected by the input operation detection unit 111 to the control unit 12. Naturally, the remote control operation signal described herein is not limited to the signals from the remote controller attached to the content processing device 10, and may be, for example, an operation signal from a smart phone or the like, operation signal from a universal remote controller, or operation signal from any other device capable of operating a TV or similar devices.

Also, what is detected by the input operation detection unit 111 is not limited to remote control operations. For example, the input operation detection unit 111 may detect operations of a button or switch mounted on a body of the content processing device 10.

The remote control operations detected by the input operation detection unit 111 include, for example, a channel change command and a volume change command as well as a command to display information linked to the current viewing content when data broadcasting is being received. Then, based on the operations detected by the input operation detection unit 111, the detection unit 11 estimates whether or not the user is interested in the current viewing content.

For example, when the remote control operation contains a command to turn up the volume or a command to display information linked to the current viewing content, the detection unit 11 can estimate that the user is interested in the current viewing content.

On the other hand, when the remote control operation contains a channel change command, the detection unit 11 can estimate that the user is interested in the content which will be provided after the channel is changed. In particular, when the user is frequently changing (zapping) the channel, the detection unit 11 can estimate that the user is interested in the content provided by the channel with which the user ends the zapping, i.e., the channel selected finally.

The control unit 12 controls the content output unit 15 based on information from the detection unit 11. Specifically, the control unit 12 includes a timer 121 which counts a predetermined time period based on an STC (System Time Clock) of the content processing device 10, a state management unit 122 which changes and manages the state of the content output unit 15 based on information sent from the detection unit 11 concerning the remote control operation signal from the user and time information from the timer 121, and a display/audio control unit 123 which outputs control information used to control the video/audio processing unit 16 according to the state managed by the state management unit 122.

The content obtainment unit 13 obtains contents from each of plural sources different from each other. Specifically, the content obtainment unit 13 includes a broadcast receiving unit 131 which obtains TV broadcasting contents via broadcast waves and a NW (network) content receiving unit 132 which obtains contents via a communication network.

The broadcast receiving unit 131 includes a tuner used to receive television broadcasting, demodulates a broadcast signal received from the tuner into a digital signal, and separates or extracts audio data, video data, character data, program description data, or the like to be processed, from the demodulated signal.

The NW content receiving unit 132 performs the process of receiving an obtainable content from the communication network via the transmitting/receiving unit 14 connected to the communication network and configured to transmit and receive data and separates or extracts audio data, video data, or the like to be processed, from the received content.

The content obtainment unit 13 configured as described above obtains plurality of contents. The contents obtained by the content obtainment unit 13 are classified into a current viewing content and candidate viewing contents.

The current viewing content is a content obtained from a first source selected by the user. For example, when the user sets the TV channel to 8ch, 8ch is the first source and a content received from the broadcasting station corresponding to 8ch is the current viewing content. Besides, the channel which is selected by default when the user powers ON the TV (generally the channel which was in a selected state just before the power was turned OFF) is also included in the “first source selected by the user.”

On the other hand, the candidate viewing content is a content obtained from a second source different from the first source. For example, the candidate viewing content may be a content selected by the content obtainment unit 13 on its own. For example, the content obtainment unit 13 may obtain meta information contained in the current viewing content and select a candidate viewing content related to the current viewing content based on the meta information.

The first and second sources refer to senders of the current viewing content and the candidate viewing content (hereinafter referred to collectively as a “content”). Normally, there is one first source. On the other hand, there may be one or more second sources.

As an example, when the first source is a broadcasting station, the broadcast receiving unit 131 obtains a current viewing content from the broadcasting station via broadcast waves. When a second source is a content server connected to the communication network, the NW content receiving unit 132 obtains a candidate viewing content from the content server.

As another example, when the first source is the broadcasting station corresponding to 8ch and second sources are the broadcasting stations corresponding to 4ch, 6ch, and 10ch, the broadcast receiving unit 131 obtains a current viewing content from the broadcasting station corresponding to 8ch, and candidate viewing contents from the broadcasting stations corresponding to 4ch, 6ch, and 10ch.

As still another example, when the first source is a content server connected to the communication network and a second source is a BD recorder connected a home network, the NW content receiving unit 132 obtains a current viewing content from the content server, and a candidate viewing content from the BD recorder.

It should be noted that, needless to say, the above is only exemplary and not restrictive. That is, combinations in the above examples may be changed or the content may be obtained from another source.

Although an example of obtaining a content other than a TV broadcasting content via the communication network is described in FIG. 1, this is not restrictive, and any content may be used as long as the content is other than the TV broadcasting content. That is, the content other than the TV broadcasting content may be any content other than the TV broadcasting content being viewed and may include redistributed programs once broadcast on TV in the past; a content recorded on a BD recorder, DVD recorder, or the like; a related content retrieved based on meta information contained in a TV broadcasting content; and so on.

In the following description, the broadcast receiving unit 131 obtains a current viewing content from the first source selected by the user and the NW content receiving unit 132 obtains a candidate viewing content from a second source different from the first source. However, needless to say, the broadcast receiving unit 131 may obtain the candidate viewing content and the NW content receiving unit 132 may obtain the current viewing content.

The content output unit 15 outputs a content (at least the current viewing content) under the control of the control unit 12, video/audio processing unit 16, and the like. Specifically, the content output unit 15 includes a display unit 151 which displays video data contained in the content and an audio output unit 152 which outputs audio data contained in the content. However, concrete examples of the content output unit 15 are not limited to this. For example, when the content processing device 10 is a BD recorder or the like, the content output unit 15 may output a signal which represents the content.

The video/audio processing unit 16 processes the TV broadcasting content obtained by the broadcast receiving unit 131 and the NW content obtained by the NW content receiving unit 132 based on information obtained from the display/audio control unit 123 of the control unit 12, and then outputs video data to the display unit 151, and audio data to the audio output unit 152.

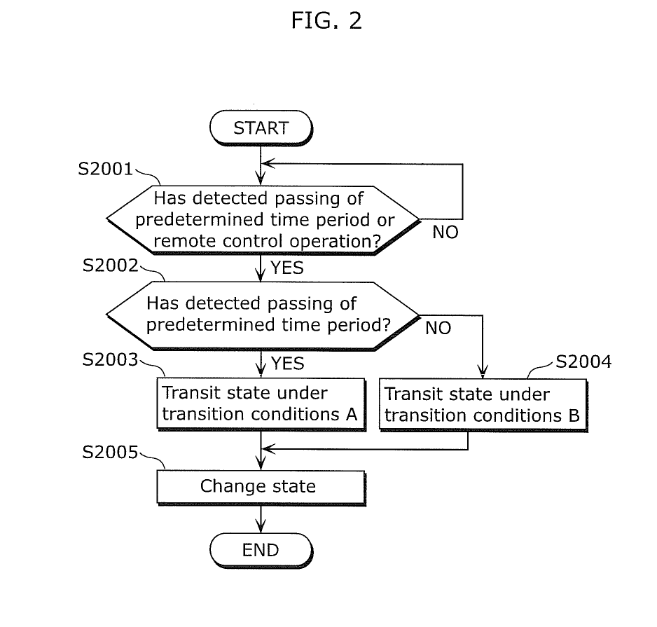

With reference to FIG. 2, description will be given of an example of how the control unit 12 controls the content output unit 15 based on the remote control operation signal notified from the detection unit 11 and time counted by the timer 121. Specifically, the control unit 12 gradually increases amounts of information of the candidate viewing contents outputted from the content output unit 15 with increases in the time period during which no user operation is detected by the detection unit 11.

(Step S2001) The state management unit 122 monitors for a signal notified from the timer 121, indicating that a predetermined time period has elapsed (hereinafter referred to as a “time-out signal”) or a remote control operation signal notified from the detection unit 11. When any of the signals described above is detected (YES in Step S2001), the state management unit 122 goes to Step S2002. When none of the signals is detected (NO in Step S2001), the state management unit 122 returns to Step S2001 to continue monitoring.

(Step S2002) When the information detected in Step S2001 is a time-out signal sent from the timer 121 (YES in Step S2002), the state management unit 122 goes to Step S2003. In the case of a remote control operation signal sent from the detection unit 11 (NO in Step S2002), the state management unit 122 goes to Step S2004.

(Step S2003) The state management unit 122 effects a state transition from a currently stored state under transition conditions A, stores the state resulting from the transition, and goes to Step S2005. Also, during the state transition in this step, the timer 121 resumes timer monitoring.

Transition conditions A are set to cause a state transition in such a way as to increase the amount of information (which corresponds to the number of screens and the like) of a content (i.e., candidate viewing contents) other than a TV broadcasting content compared to the state stored the previous time.

(Step S2004) The state management unit 122 effects a state transition from the currently stored state under transition conditions B, stores the state resulting from the transition, and goes to Step S2005. Also, during the state transition in this step, the time counted by the timer 121 is reset once before timer monitoring is resumed.

Transition conditions B are set to return the state stored the previous time to an initial state, i.e., to a state in which only the current viewing content exists (or maintain the initial state if the state stored the previous time is the initial state). Alternatively, transition conditions B may be set to cause a state transition in such a way as to decrease the amount of information (which corresponds to the number of screens and the like) of a content (i.e., candidate viewing contents) other than a TV broadcasting content compared to the state stored the previous time.

(Step S2005) Next, based on the state determined in Step S2003 or S2004, the display/audio control unit 123 notifies information about the screens displayed on the display unit 151 and information about the audio outputted from the audio output unit 152, to the video/audio processing unit 16. Then, the video/audio processing unit 16 processes the current viewing content obtained by the broadcast receiving unit 131 and the candidate viewing content obtained by the NW content receiving unit 132 so as to bring about the state informed by the display/audio control unit 123, and then outputs video data to the display unit 151, and audio data to the audio output unit 152.

In Steps S2003 and S2004, the current state stored in a memory or the like is read out and caused to transition under conditions different between Steps S2003 and S2004, and the state resulting from the transition is stored again in the memory or the like. Concrete examples of the memory include a DRAM (Dynamic Random Access Memory), SDRAM (Synchronous Dynamic Random Access Memory), flash memory, and ferroelectric memory, but are not particularly limited, and any means capable of recording data may be used.

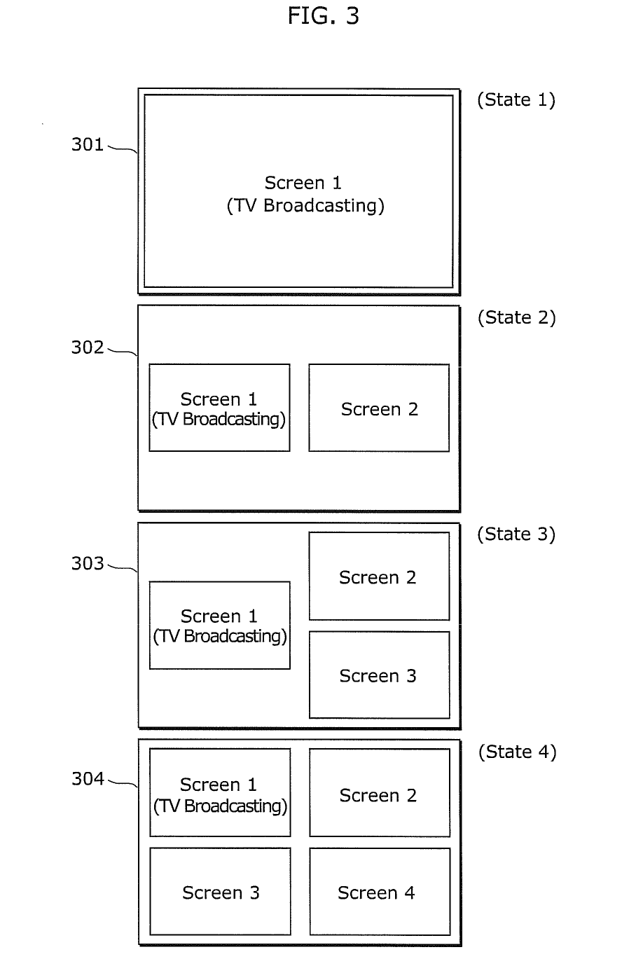

Next, an example of screens (output examples) outputted by the content processing device 10 according to the first embodiment based on state transitions will be described with reference to FIG. 3.

Output example 301 is a conceptual drawing of a screen layout in which an entire screen of the display unit 151 outputs only a TV broadcasting content (a current viewing content). Output example 302 is a conceptual drawing of a screen layout with two screens, in which one sub-screen outputs a TV broadcasting content (a current viewing content) and the other sub-screen outputs a content (a candidate viewing content) other than the TV broadcasting content. Output example 303 is a conceptual drawing of a screen layout with three screens, in which one sub-screen outputs a TV broadcasting content (a current viewing content) and the other two sub-screens output contents (candidate viewing contents) other than the TV broadcasting content. Output example 304 is a conceptual drawing of a screen layout with four screens, in which one sub-screen outputs a TV broadcasting content (a current viewing content) and the other three sub-screens output contents (candidate viewing contents) other than the TV broadcasting content.

That is, output example 301 represents a state in which the amount of information (the number of screens) of candidate viewing contents is the smallest. Then, the amount of information (the number of screens) of candidate viewing contents increases gradually from output example 302 to output example 303 to output example 304. When performing display control using output examples 301 to 304, the control unit 12 gradually increases amounts of information of the candidate viewing contents outputted from the content output unit 15 with increases in the time period during which no user operation is detected by the input operation detection unit 111.

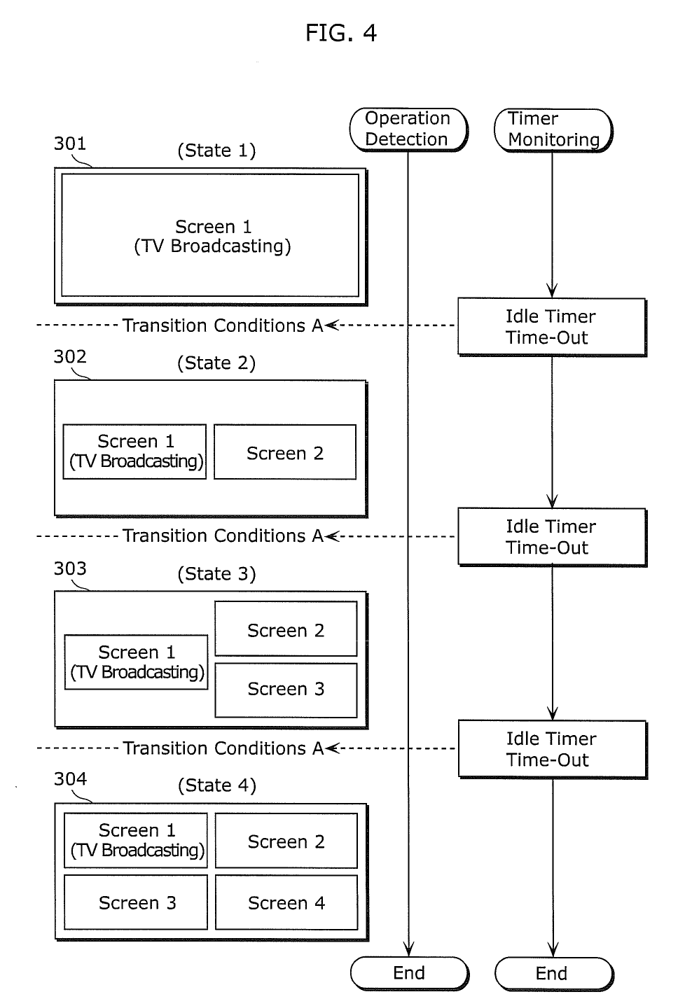

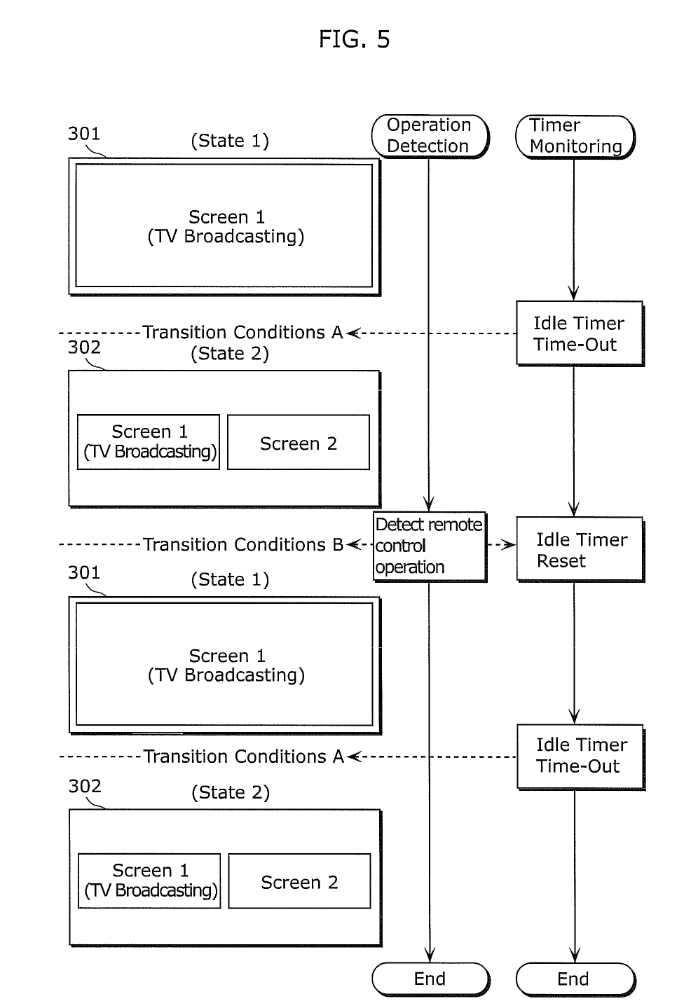

Next, an example of screens outputted by the content processing device 10 according to the first embodiment based on state transitions will be described with reference to FIGS. 4 and 5.

FIG. 4 shows how a predetermined time period elapses without any remote control operation, satisfying transition conditions A described in Step S2003 in FIG. 2 and consequently state transitions occur in sequence as illustrated by output examples 301, 302, 303, and 304 in FIG. 3.

First, in the initial state, only a TV broadcasting content (a current viewing content) is displayed on the display unit 151. In this state, when a timer (hereinafter referred to as a “idle timer”) which indicates that no operation has been detected by the input operation detection unit 111 for a predetermined time period times out (YES in Step S2002 in FIG. 2), a transition occurs from output example 301 to output example 302 according to transition conditions A. That is, the state in which only the TV broadcasting content is displayed transitions to a state in which one sub-screen outputs the TV broadcasting content and another sub-screen outputs a content other than the TV broadcasting content.

When the idle timer times out further, a transition occurs from output example 302 to output example 303 according to transition conditions A. When the idle timer times out further, a transition occurs from output example 303 to output example 304 according to transition conditions A.

In this way, when there is no remote control operation by the user, each time a predetermined time period elapses (satisfying transition conditions A), the amount of information of a content other than the TV broadcasting content is increased gradually. Thus, since the user can view the content resulting from a remote control operation in full screen until a predetermined time period elapses after the remote control operation, viewing is not obstructed.

On the other hand, if no remote control operation is inputted again even when a predetermined time period elapses after a user operation, it is determined that the user does not take any positive action with respect to TV, i.e., that the interest level of the user in the TV broadcasting content is decreasing, and consequently the amount of information of a content other than the TV broadcasting content is increased. Specifically, according to the first embodiment, the number of screens of the content other than the TV broadcasting content is increased.

FIG. 5 shows how a state transition caused by a lapse of a predetermined time period without any remote control operation (transition conditions A) and a state transition caused by detection of a remote control operation (transition conditions B) take place alternately.

First, in the initial state, only a TV broadcasting content (a current viewing content) is displayed on the display unit 151. In this state, when the idle timer times out (YES in Step S2002 in FIG. 2), a transition occurs from output example 301 to output example 302 according to transition conditions A. That is, a transition occurs from the state in which only the TV broadcasting content is displayed to a state in which one sub-screen outputs the TV broadcasting content and another sub-screen outputs a content other than the TV broadcasting content.

Next, when a remote control operation by the user is detected (Step S2004 in FIG. 2), a transition occurs from output example 302 to output example 301, i.e., to an initial screen state, according to transition conditions B, and the TV broadcasting content is outputted in full screen. At this point, the idle timer is reset.

Again, since there is no remote control operation within the predetermined time period, a transition occurs from output example 301 to output example 302 according to transition conditions A. That is, a transition occurs from the state in which only the TV broadcasting content is displayed to a state in which one sub-screen outputs the TV broadcasting content and another sub-screen outputs a content other than the TV broadcasting content.

With the above procedures, since a viewing state of the user indicates that the user is interested in a TV broadcasting content itself, as long as the user keeps changing channels, changing the volume, or carrying out similar operations with the remote controller within the predetermined time period, the user can continue viewing the TV broadcasting content in full screen, and is not obstructed from viewing.

On the other hand, if the user does not operate the remote controller to operate the TV within the predetermined time period, it is presumed that the interest level of the user in the TV broadcasting content is decreasing, and information on a content other than the TV broadcasting content is outputted by being increased gradually in amount. That is, an opportunity to provide a content other than the TV broadcasting content is given only when the interest level of the user in the TV broadcasting content itself is decreasing. Consequently, the viewing of the TV broadcasting content itself is not obstructed much, and conversely the provision of a content other than the TV broadcasting content may increase the opportunity to improve the interest level of the user in the content other than the TV broadcasting content.

This has the advantage of being able to automatically output a content other than the TV broadcasting content in such a way as to reduce obstruction to viewing of the TV broadcasting content, and thereby give the user an opportunity to be invited to a content other than the TV broadcasting content without any explicit operation by the user.

### Variation of the First Embodiment

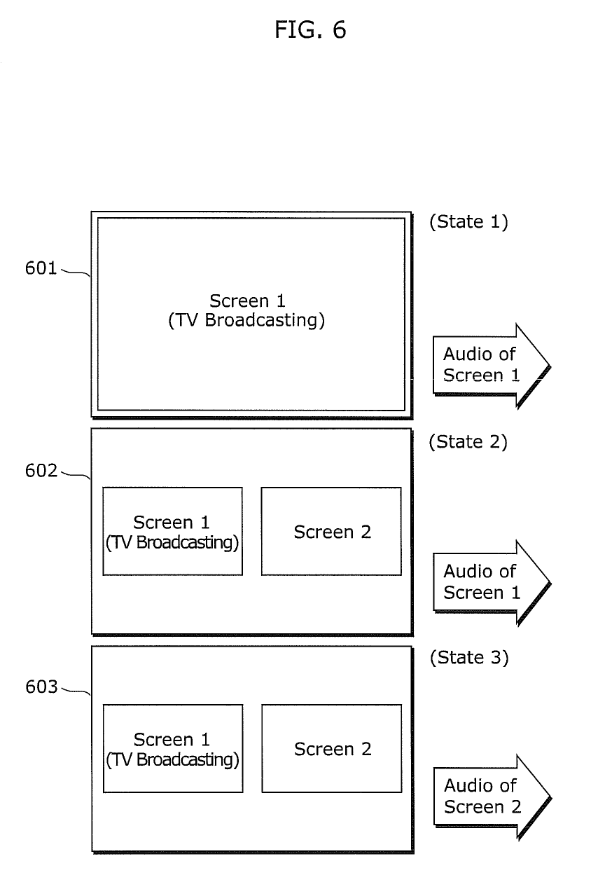

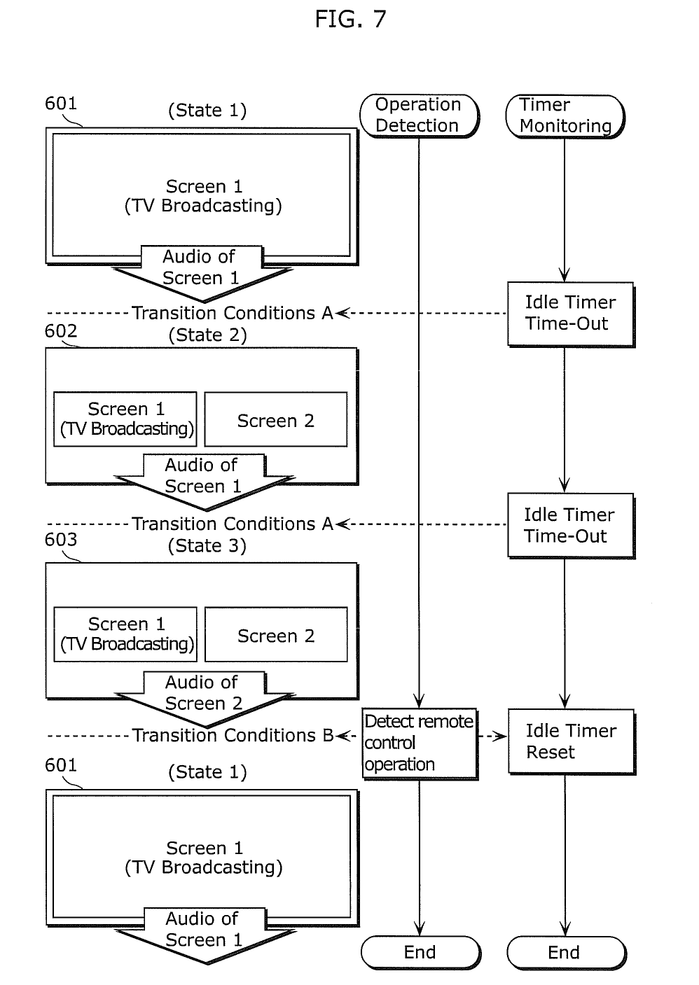

Screens outputted by the content processing device 10 based on state transitions as well as transitions of the screens have been described in FIGS. 3 to 5 according to the first embodiment. Next, with reference to FIGS. 6 and 7, description will be given of a content processing device 10 which causes a state of audio in addition to screens to transition based on state transitions.

Configuration and processing operations of the content processing device 10 according to the variation of the first embodiment are similar to those of the first embodiment shown in FIGS. 1 and 2, and thus description thereof will be omitted herein.

With reference to FIGS. 6 and 7, description will be given of an example of screens and audio outputted by the content processing device 10 according to the variation of the first embodiment based on state transitions. FIG. 6 is a diagram showing exemplary combinations (output examples) of a screen layout on the display unit 151 and audio data outputted from the audio output unit 152.

Output example 601 is a conceptual drawing of a screen layout and audio output, where video data of a TV broadcasting content is outputted to the display unit 151 and audio data of the TV broadcasting content is outputted to the audio output unit 152. Output example 602 is a conceptual drawing of a screen layout and audio output, with two screens presented on the display unit 151, where one sub-screen outputs a TV broadcasting content and the other sub-screen outputs a content other than the TV broadcasting content while the audio output unit 152 outputs audio for screen 1 corresponding to the TV broadcasting content. Output example 603 is a conceptual drawing of a screen layout and audio output, where the display unit 151 has the same screen layout as output example 602, but the audio output unit 152 outputs audio for screen 2 corresponding to a content other than the TV broadcasting content.

That is, output example 603 does not differ from output example 602 in the amount of information displayed on the display unit 151, but differs in the amount of information as a whole because of difference in the audio data outputted by the audio output unit 152. When performing display control using output examples 601 to 603, the control unit 12 controls a display area of the display unit 151 displaying the video data contained in the candidate viewing content or controls whether or not the audio data contained in the candidate viewing content will be outputted from the audio output unit 152.

Next, with reference to FIG. 7, description will be given of an example of screens and audio outputted by the content processing device 10 according to the variation of the first embodiment based on state transitions.

FIG. 7 shows how state transitions are caused by a lapse of a predetermined time period without any remote control operation (transition conditions A) and a state transition is caused by detection of a remote control operation (transition conditions B).

First, in the initial state, only a TV broadcasting content (a current viewing content) is displayed on the display unit 151. Also, the audio output unit 152 outputs the audio of the TV broadcasting content. In this state, when the idle timer times out (YES in Step S2002 in FIG. 2), a transition occurs from output example 601 to output example 602 according to transition conditions A. That is, a transition occurs from the state in which only the TV broadcasting content is displayed to a state in which one sub-screen outputs the TV broadcasting content and another sub-screen outputs a content other than the TV broadcasting content. However, the audio output unit 152 continues to output the audio of the TV broadcasting content.

When the idle timer times out further, a transition occurs from output example 602 to output example 603 according to transition conditions A. That is, although the screen layout of the display unit 151 remains the same, a transition occurs from the state in which the audio output unit 152 outputs the audio of the TV broadcasting content to a state in which the audio output unit 152 outputs the audio of the content other than the TV broadcasting content.

Next, when a remote control operation by the user is detected (Step S2004 in FIG. 2), a transition occurs from output example 603 to output example 601, i.e., to the initial state, according to transition conditions B. That is, the video data of the TV broadcasting content is displayed in full screen on the display unit 151 and the audio of the TV broadcasting content is outputted from the audio output unit 152.

Although three states have been cited in the description of FIGS. 6 and 7 for the sake of simplicity, this is not restrictive. Regarding the number of screens, the number of screens may be further increased. Regarding audio, the audio of the content other than a TV broadcasting content may be outputted or multiplexed audio may be outputted. For example, the audio data contained in the content whose video data is displayed on the largest display area of the display unit 151 may be outputted from the audio output unit 152.

Also, although only one of the screen layout and audio undergoes state transitions in the description of FIGS. 6 and 7, both screen layout and audio may be subjected to a transition simultaneously. That is, state transitions may take any form as long as a TV broadcasting content and a content other than the TV broadcasting content change in the amount of information.

With the above configuration, since the user can view the content resulting from a remote control operation in full screen until a predetermined time period elapses after the remote control operation, viewing is not obstructed. On the other hand, if no remote control operation is inputted again even when a predetermined time period elapses after a user operation, since the user does not take any positive action with respect to TV, it is determined that that the interest level of the user in the TV broadcasting content is decreasing, and consequently the amount of information of a content other than the TV broadcasting content is increased.

Specifically, in the variation of the first embodiment, the number of screens of the content other than the TV broadcasting content is increased and the output audio is switched to the audio of a content other than TV broadcasting content. Consequently, since the audio of a content other than the TV broadcasting content is provided as well, the opportunity to improve the interest level of the user in the content other than the TV broadcasting content can be increased more than in the first embodiment.

This makes it possible to automatically output a content other than the TV broadcasting content in such a way as to reduce obstruction to viewing of the TV broadcasting content. That is, the audio as well as screen of a content other than the TV broadcasting content is outputted without any explicit operation by the user, providing the advantage of being able to give the user an opportunity to be invited further to the content other than the TV broadcasting content.

### Second Embodiment

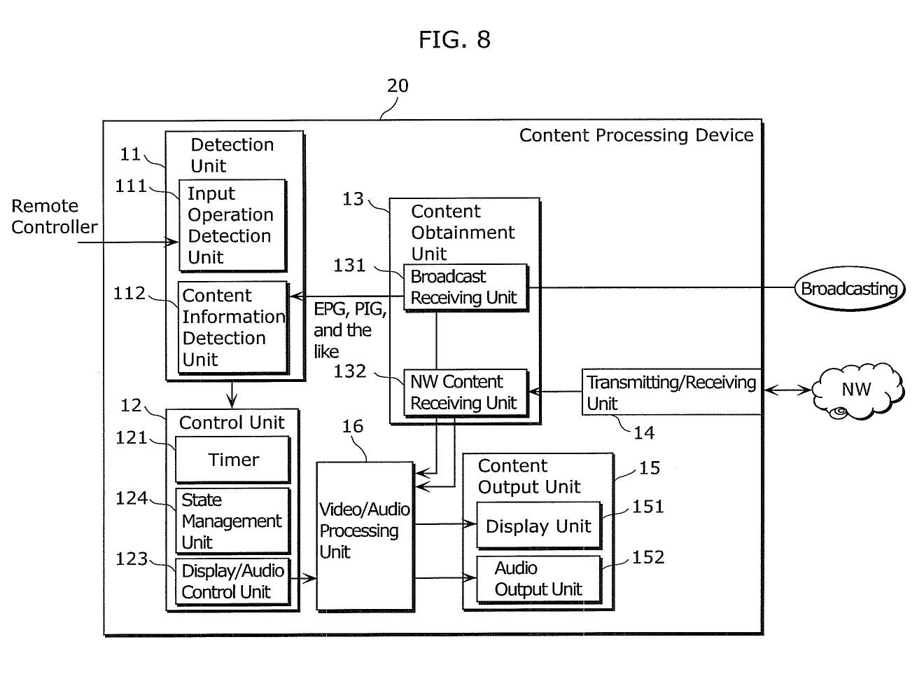

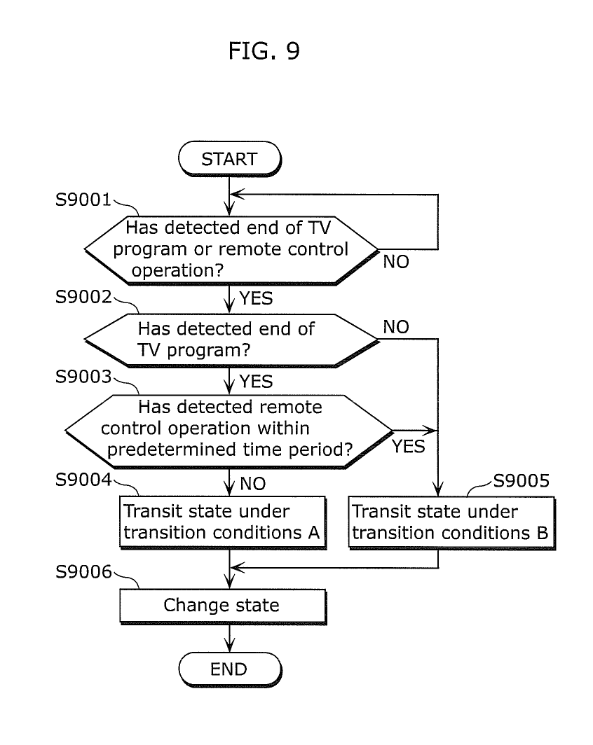

In the first embodiment and a variation thereof described above, when a predetermined time period elapses (time-out) without any remote control operation by the user, the content processing device 10 causes a state transition upon the time-out. In a second embodiment, with reference to FIGS. 8 and 9, description will be given of a content processing device 20 which causes a state transition upon a change of the TV broadcasting content from one program to another if there is no remote control operation.

FIG. 8 is a block diagram for outlining the content processing device 20 according to the second embodiment, where components similar to those of the content processing device 10 according to the first embodiment are denoted by the same reference numerals as the corresponding components, and description thereof will be omitted.

Referring to FIG. 8, the content processing device 20 according to the second embodiment has a content information detection unit 112 included in the detection unit 11 in addition to the components of the content processing device 10 according to the first embodiment. Also, a state management unit 124 according to the second embodiment differs in concrete operation from the state management unit 122 according to the first embodiment.

The content information detection unit 112 detects a program break corresponding to an end or start of a program (content) and informs the state management unit 124 via the detection unit 11. Information about the end or start of the program can be detected using, for example, an EPG (Electronic Program Guide); an EIT (Event Information Table) which contains program information such as a program name, a broadcast time and date, and broadcasting contents used in creating the EPG; PID (packet identification information) of a TS packet; and the like.

In the second and subsequent embodiments, descriptions assume that the content information detection unit 112 detects an end of a program, but information about a program change or program break such as a start of the program may be detected without limiting to the end of the program. Also, a state transition may be configured to occur when the timer 121 counts a predetermined time period based on information obtained by the content information detection unit 112.

The state management unit 124 changes and manages the state of the display screen and audio to be outputted, based on information sent from the detection unit 11 concerning the remote control operation signal from the user and on program state information sent from the content information detection unit 112 via the detection unit 11. More specifically, if no input operation by the user is detected by the input operation detection unit 111 for a predetermined time period, the control unit 12 increases the amount of information of the candidate viewing contents outputted from the content output unit 15, timed with the end of the current viewing content detected by the content information detection unit 112.

With this configuration, the content processing device 20 according to the second embodiment effects a state transition timed with the end of a program whereas the content processing device 10 according to the first embodiment effects a state transition upon lapse of a predetermined time period.

With reference to FIG. 9, description will be given below of an example of how the control unit 12 changes a state based on remote control operation information and end-of-program information sent from the detection unit 11.

(Step S9001) The state management unit 124 monitors for remote control operation information or end-of-program information sent from the detection unit 11. When any of the above is detected (YES in Step S9001), the state management unit 124 goes to Step S9002. When none of the above is detected (NO in Step S9001), the state management unit 124 returns to Step S9001 to continue monitoring.

Although it is assumed that the “end-of-program information” is sent from the content information detection unit 112 timed with the actual end of the program, the information may be obtained by another method. For example, the timer 121 may monitor for an end of the program by timer monitoring based on an EPG or the like obtained at the start of viewing of the program, and time-out information about the timer may be obtained as the “end-of-program information.”

(Step S9002) Next, if the information detected in Step S9001 concerns an end of the program detected by the content information detection unit 112 and informed via the detection unit 11 (YES in Step S9002), the state management unit 124 goes to Step S9003. If the information is remote control operation information sent by the detection unit 11 (NO in Step S9002), the state management unit 124 goes to Step S9005.

(Step S9003) Next, the state management unit 124 determines whether or not any remote control operation by the user has been detected by the input operation detection unit 111 up to now within a predetermined time period. If no remote control operation has been detected (NO in Step S9003), the state management unit 124 goes to Step S9004. If any remote control operation has been detected (YES in Step S9003), the state management unit 124 goes to Step S9005. As a concrete example, the “predetermined time” used in monitoring for a remote control operation may be set to the viewing time of the content checked for an end in Step S9002.

(Step S9004) The state management unit 124 effects a state transition from a currently stored state under transition conditions A, stores the state resulting from the transition, and goes to Step S9005. Also, during the state transition in this step, the timer 121 resumes timer monitoring.

Transition conditions A are set to cause a state transition in such a way as to increase the amount of information (which corresponds to the number of screens and the audio to be outputted) of a content other than a TV broadcasting content compared to the state stored the previous time.

(Step S9005) The state management unit 124 effects a state transition from the currently stored state under transition conditions B, stores the state resulting from the transition, and goes to Step S9006. Also, during the state transition in this step, the time counted by the timer 121 is reset once before timer monitoring is resumed.

Transition conditions B are set to return the state stored the previous time to an initial state (or maintain the initial state if the state stored the previous time is the initial state). Alternatively, transition conditions B may be set to cause a state transition in such a way as to decrease the amount of information (which corresponds to the number of screens and the audio to be outputted) of a content other than a TV broadcasting content compared to the state stored the previous time.

In Steps S9004 and S9005, the state stored in a memory or the like is read out and caused to transition under conditions different between Steps S9004 and S9005, and the state resulting from the transition is stored again in the memory or the like.

(Step S9006) Next, based on the state determined in Step S9004 or S9005, the display/audio control unit 123 sends information about the screens displayed on the display unit 151 and information about the audio outputted from the audio output unit 152, to the video/audio processing unit 16. Then, the video/audio processing unit 16 processes the current viewing content obtained by the broadcast receiving unit 131 and the candidate viewing contents obtained by the NW content receiving unit 132 so as to bring about the state informed by the display/audio control unit 123, and then outputs video data to the display unit 151, and audio data to the audio output unit 152.

States and transitions of the screen and audio outputted by the content processing device 20 based on state transitions are similar to those of the first embodiment described with reference to FIGS. 3 to 7. That is, by satisfying transition conditions A, the content processing device 20 effects a state transition timed with the end of a program whereas the content processing device 10 effects a state transition upon lapse of a predetermined time period. Otherwise, the content processing device 20 is the same as the content processing device 10, and thus description thereof will be omitted.

With the above procedures, since a viewing state of the user indicates that the user is interested in a TV broadcasting content itself, as long as the user keeps changing channels, changing the volume, or carrying out similar operations with the remote controller within the predetermined time period, the user can continue viewing the TV broadcasting content in full screen, and is not obstructed from viewing.

According to the second embodiment, since the transition of the state to be outputted is brought about with the end of a program, the display screen of the program being viewed is not changed while the program is being viewed. Thus, the second embodiment has the advantage of being able to further prevent viewing from being obstructed.

On the other hand, if the user does not operate the remote controller to operate TV within the predetermined time period, it is presumed that the interest level of the user in the TV broadcasting content is decreasing, and information on a content other than the TV broadcasting content is increased gradually in amount. That is, an opportunity to provide a content other than the TV broadcasting content is given only when the interest level of the user in the TV broadcasting content itself is decreasing. Consequently, the viewing of the TV broadcasting content itself is not obstructed much, and conversely the provision of a content other than the TV broadcasting content increases the opportunity to improve the interest level of the user in the content other than the TV broadcasting content as in the case of the first embodiment.

Consequently, there is no state change until the program being viewed ends. This makes it possible to automatically output a content other than the TV broadcasting content in such a way as to further reduce obstruction to viewing of the current TV broadcasting content, and thereby give the user an opportunity to be invited to a content other than the TV broadcasting content without any explicit operation by the user.

### Third Embodiment

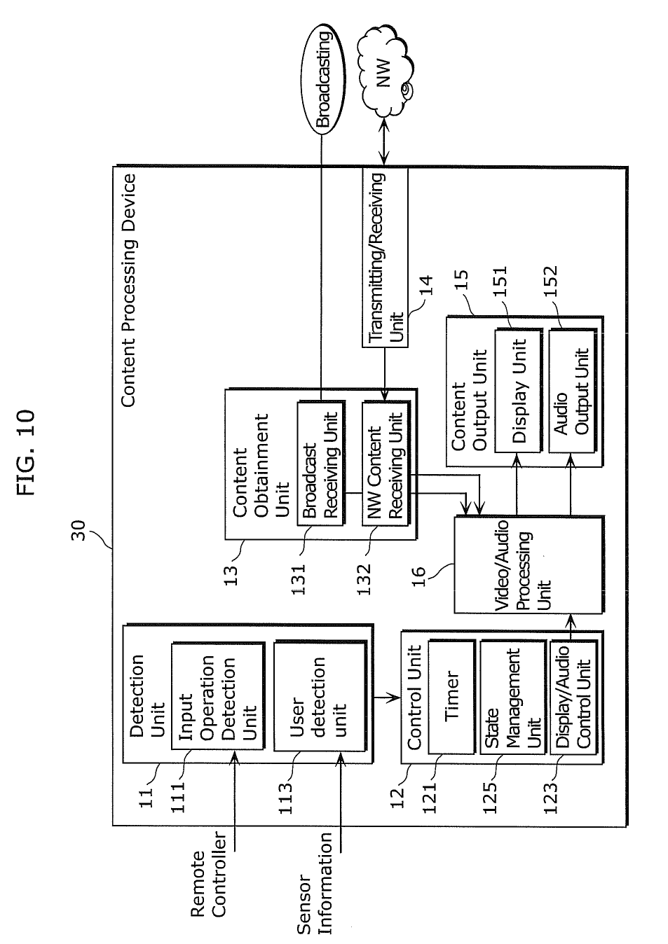

A content processing device 30 which causes state transitions based on information obtained from a sensor will be described with reference to FIG. 10.

FIG. 10 is a block diagram for outlining the content processing device 30 according to a third embodiment, where components similar to those of the content processing device 10 according to the first embodiment are denoted by the same reference numerals as the corresponding components, and description thereof will be omitted.

Referring to FIG. 10, the content processing device 30 according to the third embodiment has a user detection unit 113 included in the detection unit 11 in addition to the components of the content processing device 10 according to the first embodiment. Also, a state management unit 125 according to the third embodiment differs in concrete operation from the state management unit 122 according to the first embodiment.

The user detection unit 113 is a human sensor which detects the user around the content processing device 30 and thereby detects the user as being interested in the current viewing content.

The human sensor typically detects a person located in a circle centered at the content processing device 30 with a radius of a few meters, and more typically a person located inside the circle and within sight of the display unit 151, as a user interested in the current viewing content.

The state management unit 125 changes and manages the state of the display screen and audio to be outputted, based on remote control operation information of the user sent from the detection unit 11 and on sensor information sent from the user detection unit 113 via the detection unit 11. More specifically, if the user detection unit 113 does not detect the presence of a user for a predetermined time period, the control unit 12 increases the amount of information of candidate viewing contents outputted from the content output unit 15.

With this configuration, the content processing device 30 according to the third embodiment effects a state transition based on information from the sensor whereas the content processing device 10 according to the first embodiment effects a state transition when a predetermined time period elapses.

With the above configuration, when, for example, a human sensor is used as the sensor, a time period during which no human being is detected by the human sensor can be measured in conjunction with the timer 121 and a measurement result may be treated as the predetermined time period described in the first embodiment. Consequently, during the time period in which the human sensor does not detect any human being, it can be determined that the user is not viewing TV. This provides the advantage that it is more useful to automatically output a content other than a TV broadcasting content in such a way as not to obstruct viewing of the current TV broadcasting content.

The user detection unit 113 may be a sensor other than a human sensor. For example, the user detection unit 113 may be a line-of-sight sensor which detects the line of sight of the user around the content processing device 30 or a gesture sensor which detects gestures of the user around the content processing device 30.

For example, when the user detection unit 113 is a line-of-sight sensor, the content processing device 30 may further include an image pickup unit (camera). The image pickup unit picks up video within sight of the display unit 151. The user detection unit 113 operating as a line-of-sight sensor extracts a user from the video picked up by the image pickup unit and detects the line of sight of the extracted user. Then, if the detected line of sight is directed at the display unit 151, the user detection unit 113 may estimate that the user is interested in the current viewing content displayed on the display unit 151.

Also, when the user detection unit 113 is a gesture sensor, the content processing device 30 may include an image pickup unit such as described above. The user detection unit 113 operating as a gesture sensor extracts a user from the video picked up by the image pickup unit and detects a gesture of the extracted user. Then, if the extracted user makes a predetermined gesture, the user detection unit 113 may estimate that the user is interested in the current viewing content displayed on the display unit 151.

When, for example, the content processing device 30 can be controlled (channel change, volume change, and the like can be done) by gestures instead of the remote controller, the predetermined gesture here may be a gesture used to control the content processing device 30, but this is not restrictive.

### Other Embodiments

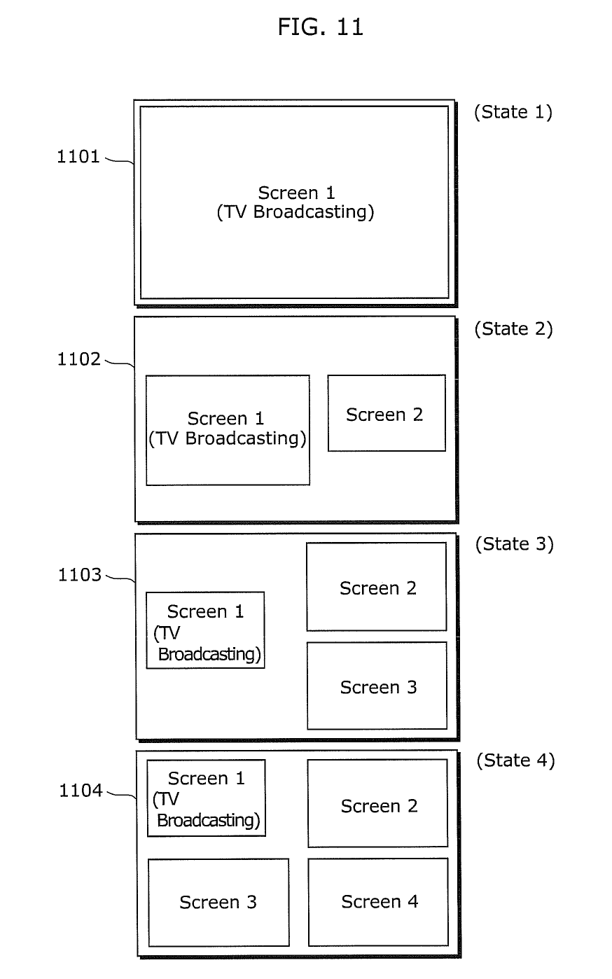

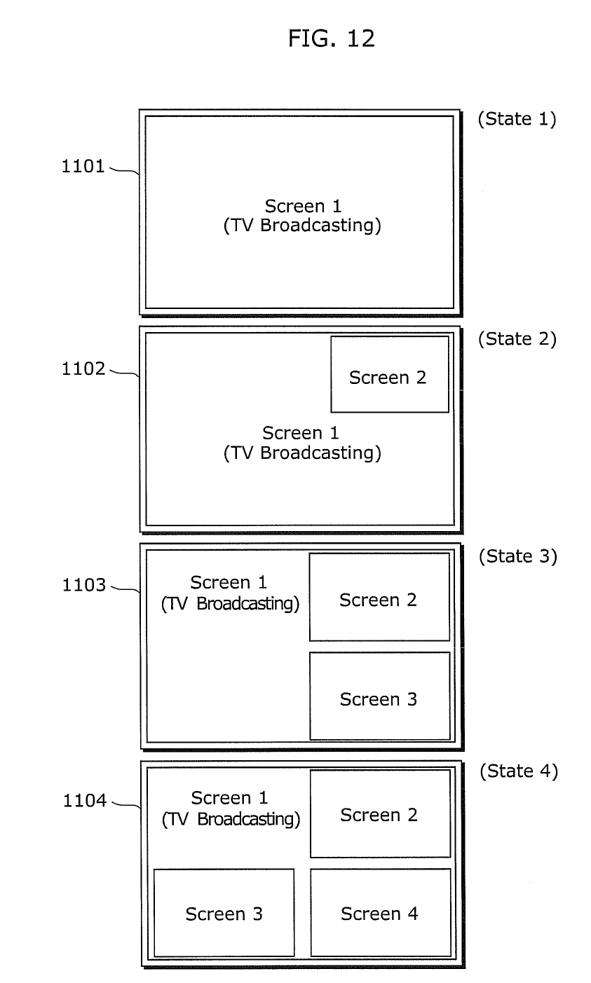

Output forms of the content output unit 15 of the content processing devices 10, 20, and 30 according to the first to third embodiments are not limited to those described in FIGS. 3 to 7, and may be, for example, as shown in FIG. 11 or 12.

FIG. 11 shows an example in which not only the number of screens is increased, but also display regions are changed on a screen by screen basis. In output examples 301 to 304 shown in FIG. 6, all the sub-screens have the same size, but in output examples 1101, 1102, 1103, and 1104 shown in FIG. 11, the size of the sub-screen varies with the state.

More specifically, in output example 1102, screen 1 (display area of a current viewing content) is larger than screen 2 (display area of a candidate viewing content). On the other hand, in output examples 1103 and 1104, screen 1 (display area of the current viewing content) is smaller than screen 2 (display area of the candidate viewing content).

FIG. 12 shows exemplary configurations in which screens are laid out in a screen. More specifically, screen 1 (display area of the current viewing content) remains the same (full-screen display) in all output examples 1201, 1202, 1203, and 1204. However, in output examples 1202, 1203, and 1204, since screens 2, 3, and 4 are superimposed on screen 1, the larger the number of sub-screens used to display candidate viewing contents, the smaller the visible region of the current viewing content. It is hoped that displaying a TV broadcasting content and a content other than the TV broadcasting content in a multiplexed fashion will give a cue for the user to view the content other than the TV broadcasting content.

The present invention has been described by referring to the above embodiments, but it should be noted that of course the present invention is not limited to this. The following cases are also included in the present invention.

The devices described above, specifically, are computer systems, each of which include a microprocessor, ROM, RAM, hard disk unit, display unit, keyboard, mouse, and the like. The RAM or hard disk unit stores a computer program. Each device achieves its functions when the microprocessor operates according to the computer program. The computer program is made up of a combination of instruction codes which specify actions to be performed by the computer in order to achieve predetermined functions.

In each of the devices described above, part or all of the components may be included in a single system LSI (Large Scale Integration). The system LSI is a super multifunctional LSI produced by integrating a plurality of components into a single chip and specifically is a computer system which includes a microprocessor, ROM, RAM, and the like. The RAM stores a computer program. The system LSI achieves its functions when the microprocessor operates according to the computer program.

In each of the devices described above, part or all of the components may be included in an IC card or discrete module attachable and detachable to/from the device. The IC card or module is a computer system which includes a microprocessor, ROM, RAM, and the like. The IC card or module may contain the super multifunctional LSI described above. The IC card or module achieves its functions when the microprocessor operates according to the computer program. The IC card or module may be configured to be tamperproof.

The present invention may be the methods described above. Alternatively, the present invention may be a computer program which implements the methods on a computer or may be digital signals of the computer program.

Also, the present invention may be a computer-readable recording medium containing the computer program or digital signals, where examples of the recording medium includes a flexible disk, hard disk, CD-ROM, MO, DVD, DVD-ROM, DVD-RAM, BD (Blu-ray Disc), and semiconductor memory. Alternatively, the present invention may be the digital signals recorded on the recording medium.

Also, the present invention may be the computer program or digital signals transmitted via a telecommunications line, a wireless or wire communications line, a network such as the Internet, data broadcasting, or the like.

Also, the present invention may be a computer system equipped with a microprocessor and memory, wherein the memory stores the computer program described above and the microprocessor operates according to the computer program.

Also, the program or digital signals may be run on another independent computer by being delivered on a recording medium or via a network or the like.

The embodiments and variations described above may be implemented in combination.

Embodiments of the present invention have been described above with reference to the drawings, but the present invention is not limited to the illustrated embodiments. Various changes and modifications can be made to the illustrated embodiments within the scope and equivalents of the present invention.

### INDUSTRIAL APPLICABILITY

Being capable of providing TV broadcasting and a content other than the TV broadcasting by automatically switching among output conditions of the TV broadcasting and another content by itself in such a way as to reduce obstruction to viewing by taking into consideration the interest level of the user in TV, the output control method for the content processing device according to the present invention is used mainly for TV and other audiovisual devices, but the output control method according to the present invention is applicable to any devices capable of obtaining two or more different contents, including general communications devices.

### NUMERICAL REFERENCES

1 Television receiver

2 BD recorder

10, 20, 30 Content processing device

11 Detection unit

12 Control unit

13 Content obtainment unit

14 Transmitting/receiving unit

15 Content output unit

16 Video/audio processing unit

111 Input operation detection unit

112 Content information detection unit

113 User detection unit

121 Timer

122, 124, 125 State management unit

123 Display/audio control unit

131 Broadcast receiving unit

132 NW content receiving unit

151 Display unit

152 Audio output unit

301, 302, 303, 304, 601, 602, 603, 1101, 1102, 1103, 1104, 1201, 1202, 1203, 1204 Output example

1. A content processing device that outputs a content, said content processing device comprising:
a content obtainment unit configured to obtain a current viewing content from a first source selected by a user, and obtain a candidate viewing content from a second source different from the first source;
a content output unit configured to output at least the current viewing content;
a detection unit configured to detect a user who is estimated as being interested in the current viewing content; and
a control unit configured to increase an amount of information of the candidate viewing content outputted from said content output unit, as a time period during which said detection unit has not detected the user estimated as being interested in the current viewing content becomes longer.

2. The content processing device according to claim 1,
wherein said detection unit includes
an input operation detection unit configured to detect the user estimated as being interested in the current viewing content, by detecting input operation from the user, and
said control unit is configured to increase the amount of the information of the candidate viewing content outputted from said content output unit, when said input operation detection unit has not detected the input operation from the user for a predetermined time period.

3. The content processing device according to claim 2,
wherein said detection unit further includes
a content information detection unit configured to detect a time of ending the current viewing content, and
said control unit is configured to increase, at the time of the ending detected by said content information detection unit, the amount of the information of the candidate viewing content outputted from said content output unit, when said input operation detection unit has not detected the input operation from the user for the predetermined time period.

4. The content processing device according to claim 1,
wherein said detection unit includes
a user detection unit configured to detect the user estimated as being interested in the current viewing content, by detecting the user around said content processing device, and
said control unit is configured to increase the amount of the information of the candidate viewing content outputted from said content output unit, when said user detection unit has not detected the user around said content processing device for a predetermined time period.

5. The content processing device according to claim 1,
wherein said content obtainment unit is configured to obtain a plurality of candidate viewing contents including the candidate viewing content, and
said control unit is configured to gradually increase the number of the candidate viewing contents outputted from said content output unit, as a time period during which said detection unit has not detected the user estimated as being interested in the current viewing content becomes longer.

6. The content processing device according to claim 1,
wherein said content output unit includes:
a display unit configured to display video data included in the content; and
an audio output unit configured to output audio data included in the content, and
said control unit is configured to (a) control a display area on said display unit for displaying the video data included in the candidate viewing content, or (b) control said audio output unit whether or not to output the audio data included in the candidate viewing content.

7. The content processing device according to claim 6,
wherein said control unit is configured to control said audio output unit to output audio data included in a content, the content including video data displayed on a largest display area on said display unit.

8. The content processing device according to claim 1,
wherein said content obtainment unit is configured to select the candidate viewing content to be obtained, based on meta information included in the current viewing content.

9. A content processing device that outputs a content, said content processing device comprising:
a content obtainment unit configured to obtain a current viewing content from a first source selected by a user, and obtain a candidate viewing content from a second source different from the first source;
a content output unit configured to output at least the current viewing content;
an input operation detection unit configured to detect input operation from the user;
a control unit configured to increase an amount of information of the candidate viewing content outputted from said content output unit, when said input operation detection unit has not detected the input operation from the user for a predetermined time period.

10. A content processing device that outputs a content, said content processing device comprising:
a content obtainment unit configured to obtain a current viewing content from a first source selected by a user, and obtain a candidate viewing content from a second source different from the first source;
a content output unit configured to output at least the current viewing content;
a user detection unit configured to detect the user around said content processing device; and
a control unit configured to increase an amount of information of the candidate viewing content outputted from said content output unit, when said user detection unit has not detected the user around said content processing device for a predetermined time period.

11. A television receiver comprising the content processing device according to claim 1,
wherein said content obtainment unit includes:
a broadcast receiving unit configured to receive the content via broadcast waves; and
a network content receiving unit configured to obtain the content via a communication network.

12. A content processing method of outputting a content, said content processing method comprising:
obtaining a current viewing content from a first source selected by a user, and a candidate viewing content from a second source different from the first source;
outputting at least the current viewing content;
detecting a user who is estimated as being interested in the current viewing content; and
increasing an amount of information of the candidate viewing content outputted in said outputting, as a time period during which the user estimated as being interested in the current viewing content has not been detected in said detecting becomes longer.
